(19) United States
(12) Patent Application Publication
(10) Pub. No.: US 2013/0069327 A1
(43) Pub. Date: Mar. 21, 2013

(54) Reversible Carrier

(71) Applicant: Don Tran, El Monte, CA (US)

(72) Inventor: Don Tran, El Monte, CA (US)

(21) Appl. No.: 13/237,037

(22) Filed: Sep. 20, 2011

(51) Int. Cl. B62B 7/14

(52) U.S. Cl. 280/47.39

(57) ABSTRACT

A reversible stroller has a frame and an extension arm extending from the frame. A pair of primary wheels is mounted to the frame. A carriage has releasable restraints adapted to restrain a rider, and the carriage has a rigid carriage body. A swivel connects the frame to the carriage so that the carriage swivels relative to the frame so that the carriage swivels between a forward position and a backward position. The frame has a truck portion of the frame, and the pair of primary wheels are mounted on the truck portion of the frame. A secondary wheel assembly is also mounted to the frame. A wheel pivot arm connects the secondary wheel assembly to the frame.

### FIELD OF THE INVENTION

The present invention is in the field of carriers.

### DISCUSSION OF RELATED ART

Strollers are used for infants and toddlers. A wide variety of reversible strollers have been created which allow the infant to face the adult user during use and then reverse to a toddler mode where the toddler is facing in the direction of travel.

Some strollers have a car seat attachment where an infant car seat can be attached to the stroller with the car seat facing the adult. Later, the car seat can be removed and the toddler can sit in the stroller seat.

### SUMMARY OF THE INVENTION

The present invention allows reversibility of the rider in the stroller carriage as well as reversibility of the user direction and user orientation. The rider can be facing forward with the user facing forward. The rider can be facing backward with the user facing forward. The rider can be facing forward with the user facing backward, and the rider can be facing backward with the user facing forward. Thus, the rider and the user can be facing in either the forward or backward position and the position of the stroller carriage as well as the user orientation can be hand adjusted in the field without use of tools.

A reversible stroller has a frame and an extension arm extending from the frame. A pair of primary wheels is mounted to the frame. A carriage has releasable restraints adapted to restrain a rider, and the carriage has a rigid carriage body. A swivel connects the frame to the carriage so that the carriage swivels relative to the frame so that the carriage swivels between a forward position and a backward position. The frame has a truck portion of the frame, and the pair of primary wheels are mounted on the truck portion of the frame. A secondary wheel assembly is also mounted to the frame. A wheel pivot arm connects the secondary wheel assembly to the frame.

A first retainer connects to the frame and mounts to releaseably engage the rigid carriage body from the frame. A swivel yoke connects the carriage body to the swivel, and the swivel yoke connects to the carriage body at a first tilt swivel and at a second tilt swivel. The extension arm has a length adjustment mechanism to vary the length of the extension arm from the frame. A vertical extension extends from the extension arm, and the vertical extension has a vertical adjustment mechanism to vary the height of the vertical extension relative to the extension arm. A harness assembly is mounted to the extension arm allowing the user to pull or push.

The pair of ground contact members can be formed as a pair of primary wheels mounted on the truck portion of the frame. The secondary ground contact member assembly can be formed as a secondary wheel assembly mounted to the frame.

### BRIEF DESCRIPTION OF THE DRAWINGS

FIG. 1 is a perspective view of the stroller in a drawn position where the user is drawing the stroller.

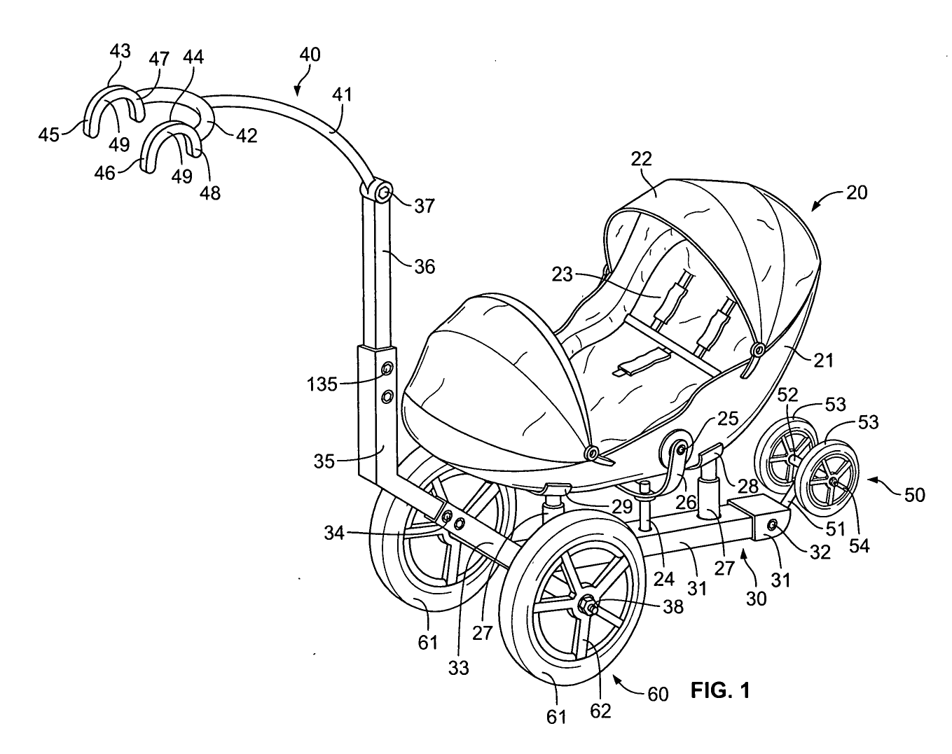

FIG. 2 is a perspective view showing the user drawing a stroller.

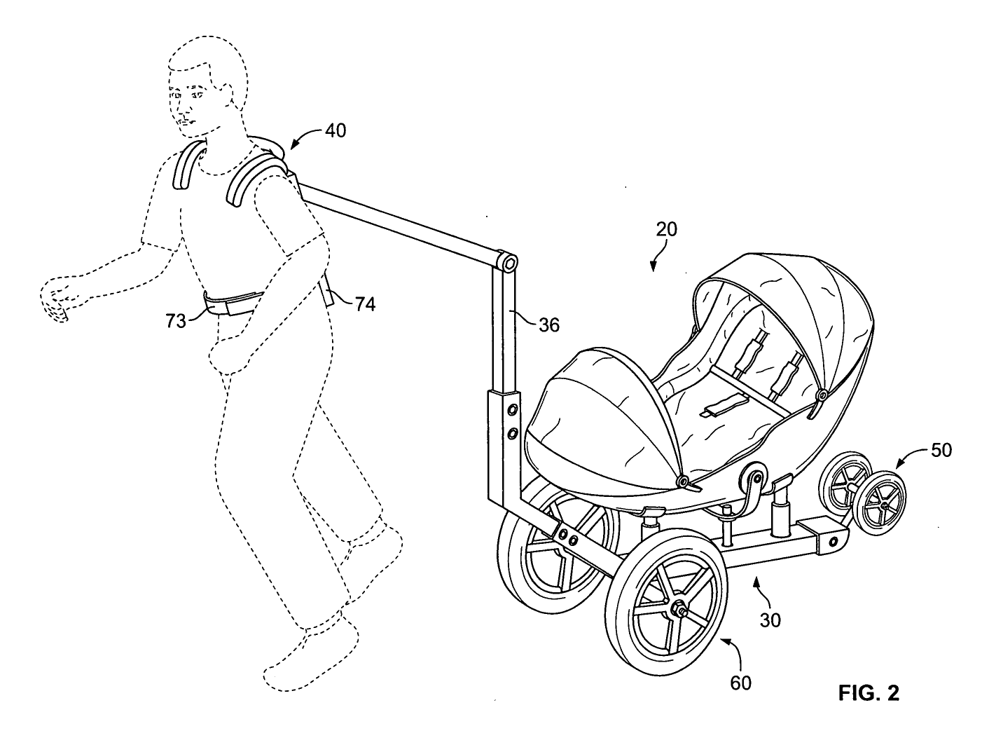

FIG. 3 is a side view of the user pushing the stroller where the stroller is configured in a pushed position.

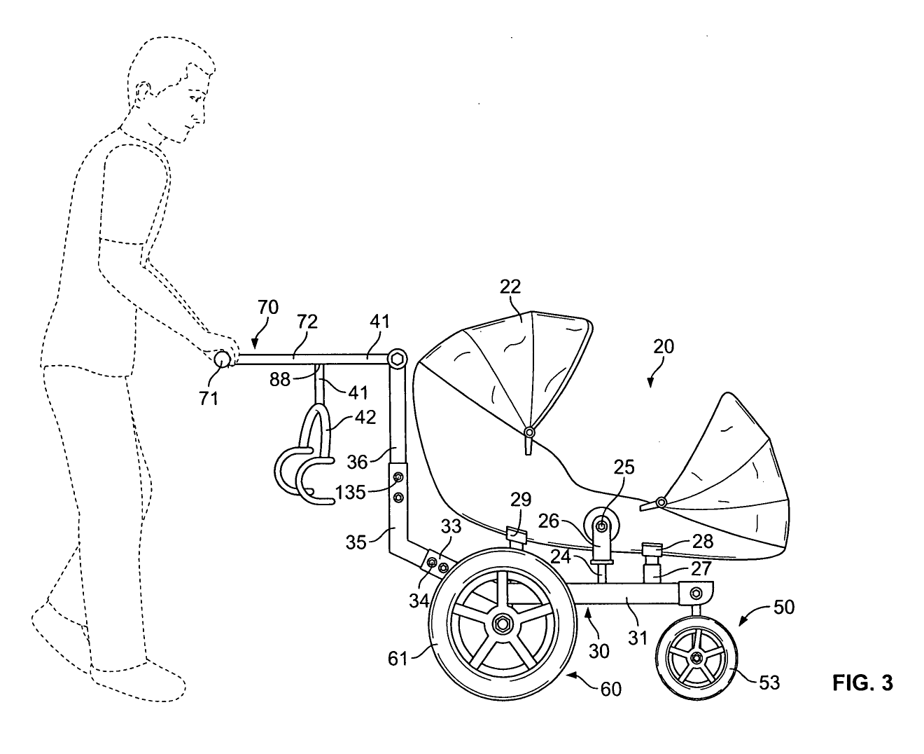

FIG. 4 is a side view of the carrier with skis as ground contact members.

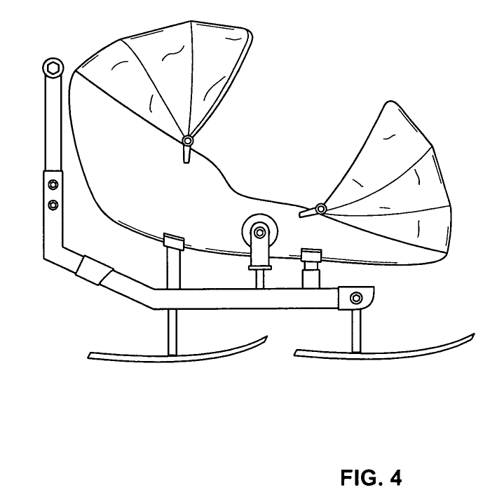

The following callout list of elements can be a useful guide in referencing the elements of the drawings.
20 Carriage
21 Carriage Body
22 Shade
23 Restraints
24 Swivel Post
25 Tilt Swivel
26 Swivel Yoke
27 Retainer Post
28 First Retainer
29 Second Retainer
30 Frame
31 Frame Cap
32 Frame Cap Pivot
33 Frame Truck
34 Frame Extension Length Adjustment
35 Extension Arm
135 Vertical Adjustment
36 Vertical Extension
37 Extension Pivot
38 Wheel Axle
40 Harness Assembly
41 Harness Arm
42 Harness Yoke
43 Right Harness Shoulder Apex
44 Left Harness Shoulder Apex
45 Right Harness Pull Member
46 Left Harness Pull Member
47 Right Harness Push Member
48 Left Harness Push Member
49 Harness Concave
50 Secondary Wheel Assembly
51 Wheel Pivot Arm
52 Wheel Pivot Truck
53 Wheel Tire, Ground Contact Member
54 Spoke
60 Primary Wheel Assembly
61 Wheel Tire
62 Spoke
70 Handle Assembly
71 Handle Grip
72 Handle Arm
88 Handle Arm Connector

### DETAILED DESCRIPTION OF THE PREFERRED EMBODIMENT

The present invention allows not only the reversibility of the rider seat portion, but also of the adult operator user. Generally, the carriage 20 holding the rider is mounted on a frame 30. A secondary wheel assembly 50 and a primary wheel assembly 60 are mounted to the frame. A harness assembly 40 is connected to the frame. The handle assembly 70 can be connected to the harness assembly 40.

The carriage 20 has a carriage body 21 supporting the rider. One or more shades 22 can be secured to the carriage body 21. Restraints 23 can be formed as straps or belts with buckles and clasps for securing the rider. The carriage body 21 is mounted to a tilt swivel 25. The tilt swivel 25 can be formed as a pair of independent tilt swivels connected to a swivel yoke 26. The swivel yoke 26 can rotate on a swivel post 24. The swivel post 24 is mounted to the frame 30. The frame 30 may further include one or a pair of retainer posts 27. A pair of retainer posts 27 may secure a first retainer 28 and a second retainer 29. The retainer post can be telescopic with the first retainer or with the second retainer. The first retainer and the second retainer make secure connection to the carriage body 21.

The first retainer and second retainer can be released from the carriage body to allow the carriage body to rotate 180° and resecure to the first retainer and do the second retainer. The retainer post 27 is preferably rigidly mounted to the frame 30 and is preferably a part of the frame 30.

The frame 30 forms a truck supporting between a pair of primary wheels in the primary wheel assembly 60. In an alternative embodiment, the ground contact member can be skis instead of wheels such that primary skis would be used instead of primary wheels and secondary skis could be used instead of secondary wheels. The primary wheels have fixed connection at a wheel axle 38 of the frame 30. Each primary wheel further includes a tire 61 which is preferably a solid tire and spokes 62 on the wheel. The primary wheel preferably does not tilt to steer relative to the frame 30 because during use, the primary wheels can be used alone.

A secondary wheel assembly 50 is pivotally mounted to a frame cap 31 which is secured to the frame 30. The frame cap pivot 32 can be mounted to the frame cap to allow the secondary wheel assembly 50 to pivot. The secondary wheel assembly can also receive a tilting junction to allow steering as if it were a caster wheel. The pivotal mounting allows the secondary wheel assembly 52 flips up into a raised position as seen in the first figure and then flip down into a lowered position as seen in the third figure. The secondary wheel assembly has a wheel pivot arm 51 mounted to the frame and a wheel pivot truck 52 upon which the secondary wheels are mounted. The secondary wheels have a tire 53, also preferably solid and the secondary wheels also preferably have spokes 54.

A handle assembly 70 allows a user to manipulate a handle arm 72 using a handle grip 71. The handle grip 71 is height adjustable at a vertical extension 36 which is in telescopic connection to an extension arm 35 which has a vertical adjustment 135. The extension arm 35 is formed at an angle. The frame extension length adjustment 34 extends the extension arm 35 toward and away from the frame truck 33. The length adjustment and height adjustment provide a fully adjustable system for placement on the handle grip 71. The length adjustment and height adjustment also control the placement of the harness assembly 40.

The handle assembly 70 allows a user to steer the stroller. The handle assembly 70 can also be made as the harness assembly. For example, a portion of the harness yoke 42 can form the handle grips 71. The harness arm 21 preferably pivots on an extension pivot 37 relative to an extension arm 36. The handle assembly 70 could also have separate handle grips 71 from the harness yoke. The belt 73 could be used for securing the belt frame 74 to the user. The belt frame then attaches to the handle arm 72.

In the handle arm can be removably attached at a handle arm connector 88. The harness assembly 40 has a harness arm 41 mounted to the extension pivot 37 and the harness connects to the harness yoke 42 so that the harness yoke 42 can support a right harness and a left harness. The right harness has a right harness pull member 45 and a right harness push member 47 forming a right harness shoulder apex 43 over a harness concave 49. The left harness has a left harness shoulder apex 44 and harness concave 49 formed between the left harness pull member 46 and the left harness push member 48. The harness concave is shaped in a concave profile to provide connection to a shoulder. The harness concave can be padded for comfort, and can include a grip so that it functions as a handle grip 71. Alternatively, the harness yoke 42 can function as a handle grip 71. Alternatively, the handle grip 71 can be independent from the harness assembly. Alternatively, the right harness pull member 45 and the left harness pull member 46 can constitute the handle grip 71. The harness assembly 40 is suspended from the extension pivot 37.

The present invention can be modified with various adapters. For an outdoor hunting or fishing carrier, a hunter can use the carrier as a rack to carry big game instead of carrying it a long distance. You can also use the carrier to hold gear and hunting equipment to the hunting spot. A fisherman can use the carrier to carry gear into the woods or lake. Hikers and mountaineers can use a backpackers carrier instead of carrying a large backpack. A winter version can be used for snow with adapters put on skis on the wheels to allow skiers to go cross country.

A military version can be used for carrying a wounded soldier to safety or to haul military equipment. The carrier carriage can be made of bullet resistant material and the The carrier could also carry ammunition for loading a helicopter or under the wings of a jet-fighter/bomber.

Therefore, while the presently preferred form of the system has been shown and described, and several modifications thereof discussed, persons skilled in this art will readily appreciate that various additional changes and modifications may be made without departing from the spirit of the invention, as defined and differentiated by the following claims.

1. A reversible stroller comprising:
a. a frame;
b. an extension arm extending from the frame;
c. a pair of ground contact members mounted to the frame;
d. a carriage having releasable restraints adapted to restrain a rider, wherein the carriage has a rigid carriage body;
e. a swivel connecting the frame to the carriage so that the carriage swivels relative to the frame so that the carriage swivels between a forward position and a backward position.

2. The reversible stroller of claim 1, further comprising a truck portion of the frame, wherein the pair of ground contact members are formed as a pair of primary wheels mounted on the truck portion of the frame.

3. The reversible stroller of claim 1, further comprising a secondary ground contact member assembly formed as a secondary wheel assembly mounted to the frame.

4. The reversible stroller of claim 3, further comprising a wheel pivot arm connecting the secondary wheel assembly to the frame.

5. The reversible stroller of claim 4, wherein the wheel pivot arm pivots from a raised position to a lowered position.

6. The reversible stroller of claim 1, further comprising a first retainer connected to the frame and mounted to releaseably engage the rigid carriage body.

7. The reversible stroller of claim 1, further comprising a swivel yoke connecting the carriage body to the swivel, wherein the swivel yoke connects to the carriage body at a first tilt swivel and at a second tilt swivel.

8. The reversible stroller of claim 1, wherein the extension arm has a length adjustment mechanism to vary the length of the extension arm from the frame.

9. The reversible stroller of claim 8, further comprising a vertical extension extending from the extension arm, wherein the vertical extension has a vertical adjustment mechanism to vary the height of the vertical extension relative to the extension arm.

10. The reversible stroller of claim 1, further comprising a harness assembly mounted to the extension arm.

11. A reversible stroller comprising:
a. a frame;
b. an extension arm extending from the frame;
c. a pair of primary wheels mounted to the frame;
d. a carriage having releasable restraints adapted to restrain a rider, wherein the carriage has a rigid carriage body;
e. a swivel connecting the frame to the carriage so that the carriage swivels relative to the frame so that the carriage swivels between a forward position and a backward position;
f. a truck portion of the frame, wherein the pair of primary wheels are mounted on the truck portion of the frame;
g. a secondary wheel assembly mounted to the frame; and
h. a wheel pivot arm connecting the secondary wheel assembly to the frame.

12. The reversible stroller of claim 11, further comprising a first retainer connected to the frame and mounted to releaseably engage the rigid carriage body.

13. The reversible stroller of claim 11, further comprising a swivel yoke connecting the carriage body to the swivel, wherein the swivel yoke connects to the carriage body at a first tilt swivel and at a second tilt swivel.

14. The reversible stroller of claim 11, wherein the extension arm has a length adjustment mechanism to vary the length of the extension arm from the frame.

15. The reversible stroller of claim 14, further comprising a vertical extension extending from the extension arm, wherein the vertical extension has a vertical adjustment mechanism to vary the height of the vertical extension relative to the extension arm.

16. The reversible stroller of claim 15, further comprising a harness assembly mounted to the extension arm.
